(19) United States
(12) Patent Application Publication
(10) Pub. No.: US 2011/0186247 A1
(43) Pub. Date: Aug. 4, 2011

(54) VEHICLE PRIVACY SCREEN

(76) Inventors: Benjamin D. Wild, Oceanside, CA (US); James F. Weintre, Oceanside, CA (US)

(21) Appl. No.: 12/830,929

(22) Filed: Jul. 6, 2010

Related U.S. Application Data
(63) Continuation-in-part of application No. 11/827,820, filed on Jul. 13, 2007, now abandoned.
(60) Provisional application No. 60/831,182, filed on Jul. 14, 2006.

(51) Int. Cl. B60J 9/00

(52) U.S. Cl. 160/351

(57) ABSTRACT

A vehicle mounted privacy screen comprising a screen panel, at least one removable attachment member associated with each of at least two opposed portions of the screen panel and a connection member extending from the screen panel that connects the screen panel to the removable attachment member.

### REFERENCE TO RELATED APPLICATIONS

This application is a continuation in part of U.S. application Ser. No. 11/827,820, filed on Jul. 13, 2007, which claims priority to U.S. Provisional Patent Application No. 60/831,182 filed on Jul. 14, 2006.

### FIELD OF THE INVENTION

The present invention relates to the field of portable privacy screens or drapes and, more particularly, to a portable privacy screen or drape for use with a vehicle.

### BACKGROUND OF THE INVENTION

There are occasions when a person needs heightened privacy around their vehicle, i.e., to change in and out of sporting attire or other gear associated with outdoor recreation. Many people are forced to use their vehicle only, or merely a towel wrapped around their bodies, for privacy. This sometimes makes changing uncomfortable due to the small spaces of a vehicle compartment and/or the limited privacy afforded by the interior of a vehicle. Attaching a screen or drape to the open doorway of a vehicle provides a greater area for freedom of movement, and greater and more secure privacy rather than merely wrapping a towel around one's body.

### SUMMARY OF THE INVENTION

The present invention is directed generally to a vehicle mounted privacy screen comprising a screen panel, at least one removable attachment member associated with each of at least two opposed portions of the screen panel and a connection member that connects the screen panel to the removable attachment member.

The screen panel can be formed of any suitable natural and/or synthetic material. Preferred materials, however, include terrycloth towels, which can serve a dual purpose as a towel and can be washed if they get dirty, and lightweight materials, such as polyesters and the like, which are more easily packable and less expensive.

The screen panel can be formed in any shape, with a rectangular shape being preferred. In a variation of the preferred embodiment, the screen panel can include an additional window extension section such that the window extension section covers the adjacent vehicle window when the screen panel traverses an open doorway of the vehicle.

The removable attachment member can be any device that is removably attachable to the vehicle and is capable of supporting the screen panel in a screening position. In a preferred embodiment, the removable attachment member can be one or more magnets, suction cups, static films, hooks, clips, straps or the like, or combinations thereof, with magnets being most preferred. When magnets or other metallic attachment members are used, it is preferred that they have a non-scratch coating or covering, or are placed within a covering, so that they do not mark the finish of the vehicle.

The connection member can also be any suitable device or devices that are capable of connecting the screen panel to the removable attachment member with the attachment member extending from the body of the screen panel. These can include elements formed separate from the screen panel, as a part of the screen panel or combinations thereof.

In one embodiment, the connection member includes a connector, such as a line, string, rope, wire, strap, extended pocket, etc. that is coupled to or which contains the removable attachment member, that extends from the screen panel, and retention member for holding the connector to the screen panel. Although the retention member can be fixed to the screen, i.e., one or more holes, rings, rivets or grommets through which a line passes, or stitching, adhering or sealing the connector directly to the screen panel, the retention member can also be a releasable member, such as clips, catches, snaps, clamps, clasps, Velcro, pins, tabs or the like, such that the connectors and attachment members can be removed from the screen panel for cleaning of the screen panel, etc.

The connection member may also include adjustable sliders, or movable stops, that can assist in holding the screen panel in an open or a closed position. This is most preferred when the retention members are capable of sliding on the connector, i.e., when the retention members are holes or grommets, or when the retention member may otherwise slide along the connector.

Additionally, the connection member can be coupled to the removable attachment member in any suitable fashion, including using permanent and removable attachments. For example, the removable attachment member can be fixed to the connector by such means as adhesives, stitching, crimps, placing the attachment member in a sealed or closed pocket or, especially when a nylon rope connector is used, melting the connector end or the connector.

Alternatively, the attachment member can be removable from the connector, such as by means of ties, clips, snaps, clasps, hooks, catches, Velcro, screws, fasteners, pins, tabs, knotting or the like, or placement of the attachment member in a connector forming an openable pocket. When using an openable pocket as the connector, the pocket may be maintained in a closed relationship using any of the aforementioned ties, clips, snaps, clasps, hooks, catches, Velcro, screws, fasteners, pins, tabs, knotting, or the like, or may use overlapping pocket flaps to retain the attachment member in the openable pocket.

The connection member can be adjustable, so that the distance between the attachment member and the screen panel can be adjusted for particular uses. For example, when the connector is formed as a strap attached to or integral with the privacy screen, the strap may have a series of elements that can be used for coupling the removable attachment member to the screen panel at different location.

Of course, additional removable attachment members can be used, i.e., to secure additional locations or portions of the screen panel to the vehicle. These can be used at opposing areas of the screen panel or at single locations, as desired. Most preferably, removable attachment members can be placed at each terminal corner of the screen panel. In this regard, terminal corners are considered to be those that are formed of less than 180° of material at the point where the connection member connects with the screen panel.

Other novel features that are considered useful elements of the present invention, although not necessarily essential to the invention, include indicators to distinguish the top of the screen panel from the bottom of the screen panel. Although any indicator can be used, a preferred indicator is a contrasting color on one or more connectors, i.e., different color connectors at the top of the screen panel.

Another novel feature is the use of a storage pocket on the screen panel into which the privacy screen can be inserted when not in use. In the most preferred embodiment, the storage pocket has one or more closures to keep the storage pocket closed with the privacy screen therein when the privacy screen is not in use.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is an elevation of a first embodiment of the vehicle mounted privacy screen of the present invention.

FIG. 2A is a partial view of a first coupling of the connector to the removable attachment member of the present invention.

FIG. 2B is a partial view of an alternative coupling of the connector to the removable attachment member of the present invention.

FIG. 3 is a front schematic view of a preferred arrangement of the removable attachment members to a vehicle.

FIG. 4 is a rear schematic view of a first embodiment of the vehicle mounted privacy screen mounted on a vehicle.

FIG. 5 is an alternative version of a screen panel for use with the present invention.

FIG. 6 is a second alternative version of a screen panel for use with the present invention, including a window extension section.

FIG. 7 is a preferred embodiment of a vehicle mounted privacy screen according to the present invention, where the connectors containing the attachment members are coupled to the screen panel and extend therefrom.

FIG. 8 is an alternative preferred embodiment of the vehicle mounted privacy screen shown in FIG. 7, which includes a window extension section.

### DETAILED DESCRIPTION OF THE PREFERRED EMBODIMENT

In the preferred embodiment, a screen or drape is adapted to cover the open doorway of a vehicle to provide a greater area for freedom of movement, and greater and more secure privacy, than merely wrapping a towel around one's body.

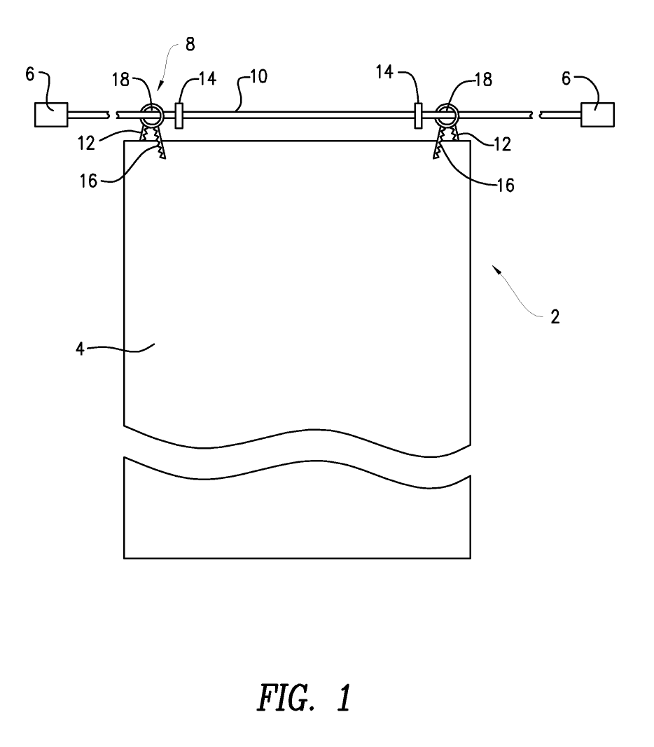

A first embodiment of the vehicle mounted privacy screen 2 of the present invention, as shown in FIG. 1, comprises a screen panel 4, at least one removable attachment member 6 associated with each of at least two opposed portions of the screen panel 4 and a connection member 8 that connects the screen panel 4 to the removable attachment member 6.

The connection member includes a connector 10 that is coupled to the removable attachment member 6, and retention members 12 for holding the screen panel. Although the connector 10 is shown as a line with an attachment member 6 at each end and two retention members 12 thereon, it could be a shorter length extending between one attachment member 6 and one retention member 12.

The retention members 12 can be fixed to the screen, i.e., using one or more rivets or crimps or holes, rings, stitching, adhesives, sealing or grommets through which a connector 10 passes, however, the retention members 12 may be releasable, including a release element such as a clip, catch, snap, clamp, clasp, Velcro, pin, tab or the like. In the embodiment shown in FIG. 1, the retention members 12 are clips that can be secured in a closed configuration about a portion of the screen panel 4 and opened to release the screen panel 4.

The retention member 12 shown in FIG. 1 includes not only a clamp 16 for retaining the screen panel 4, but also an aperture 18 which receives the connector 10 and on which the retention member can slide, for sliding the screen panel 4 into an open or closed configuration.

The connection member 8 shown here also includes two movable stops 14 that can assist in holding the screen panel 4 in a closed position. Preferably, the stops 14 are line clamps, which have a central opening to receive a line and a spring loaded clamp. When a button associated with the line clamp is depressed, the line is released and the stop 14 can be moved to a desired position. When the button is released, the clamp engages the line and the stop 14 is fixed in position.

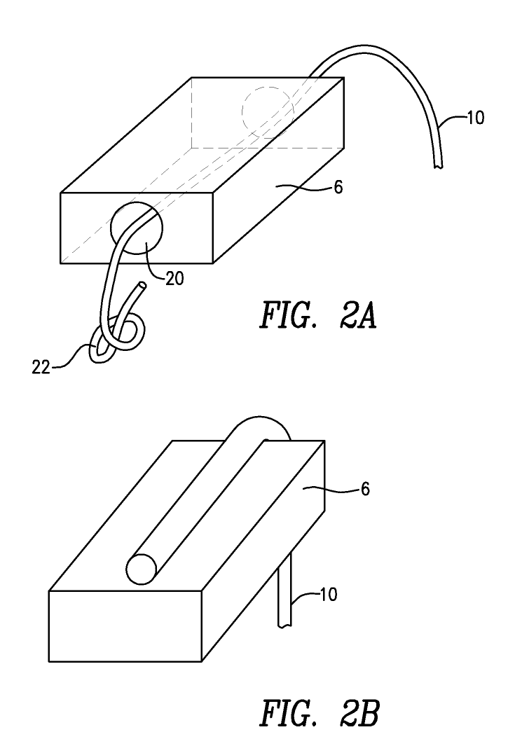

Although any suitable means for coupling the connector 10 to the removable attachment member 6 is anticipated for practicing the present invention, FIGS. 2A and 2B demonstrate acceptable methods. In FIG. 2A, the connector 10 passes through an aperture 20 in the removable attachment member 6 and is knotted such that the knot 22 is not capable of passing back through the aperture 20. The knot 22 can be fixed in a knotted configuration, i.e., by melting the line when a nylon rope is used as the connector 10, or merely left in a tied state, so that the connector 10 can be untied for removal from the attachment member 6 if desired.

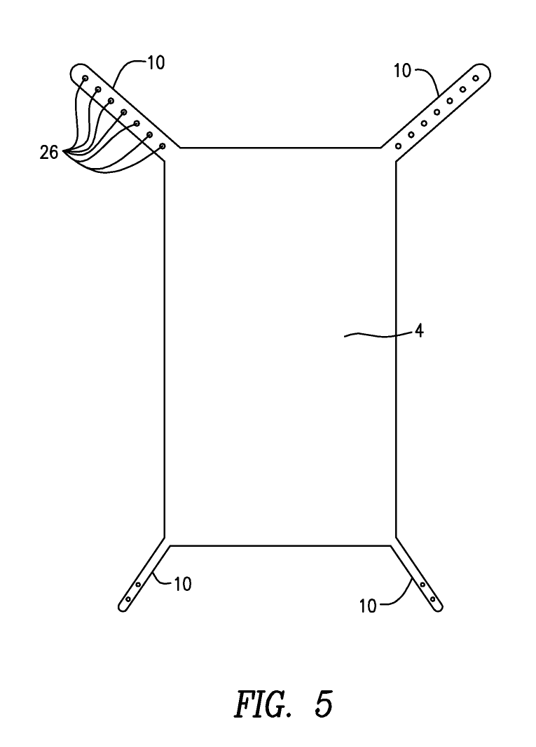

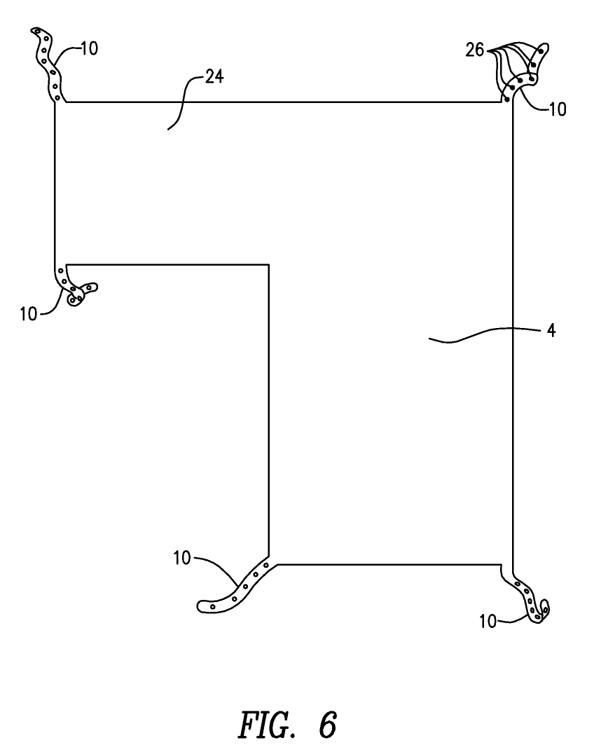

Additionally, the coupling of the connector 10 to the attachment member 6 can utilize an adjustable coupling, with clamps, clips, snaps, etc. Such an embodiment would allow for the length of the connector 10 to be adjusted rather than moving the placement of the attachment members 6 closer or farther away from each other on the vehicle. Examples of this arrangement are shown in FIGS. 5 and 6, discussed below.

The screen panel 4 can be formed of any suitable material, as described above. A terrycloth towel has at least two advantages, where it can serve as a towel and can be washed or replaced with another towel if it gets dirty. However, a lightweight material, such as a polyester or the like, may be preferred, where it forms a screen panel that is more easily packable, lighter weight, harder to get dirty and less expensive.

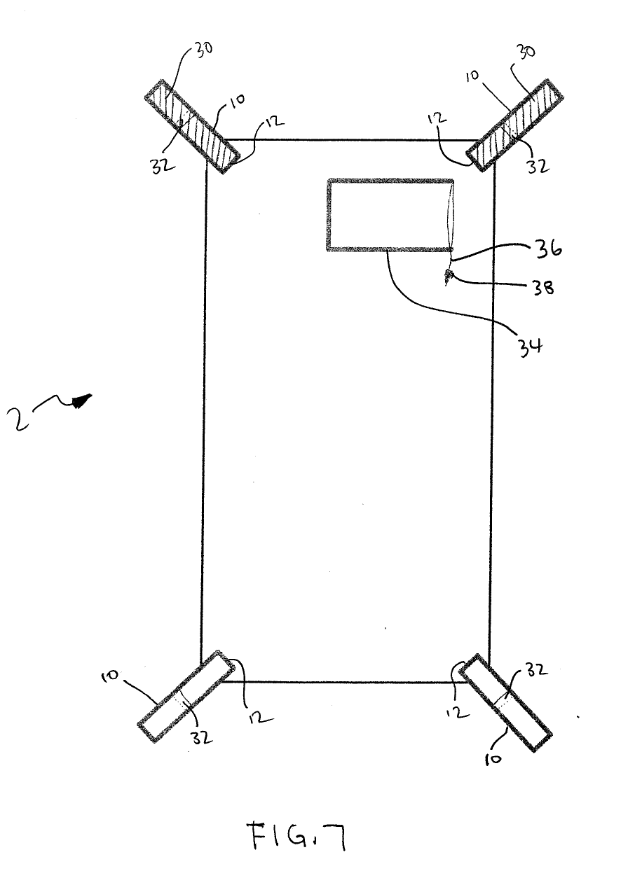

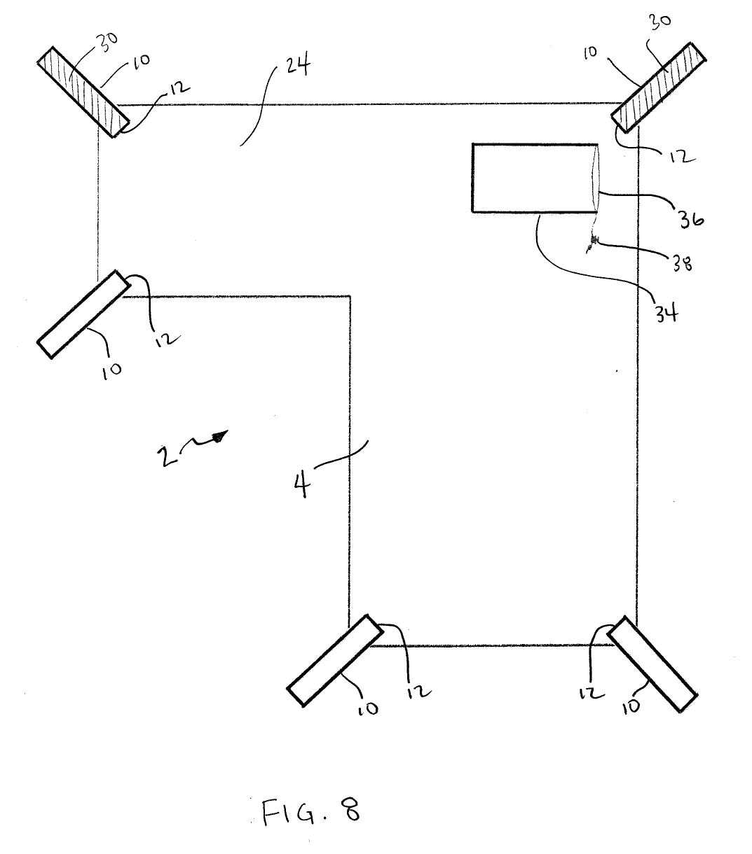

The screen panel 4 may also be formed of any suitable shape, the most simple of which is a rectangle. However, for increased privacy, the screen panel 4 may have a window extension section 24. These embodiments are best shown in FIGS. 5 and 6 and in FIGS. 7 and 8, respectively, which also show the connector 10 as tabs extending from the screen panel 4.

In the embodiment of FIGS. 5 and 6, the connectors 10 have a series of coupling elements 26 that allow the user to adjust the fit of the screen panel 4 to the attachment members 6. In these embodiments, the coupling elements 26 on the connectors 10 are preferably releasable members that cooperate with mating members on the attachment members 6, such as snaps, clips, Velcro, catches, pins, hooks or the like. For example, the coupling member may be a snap that cooperates with a mating snap on the attachment member 6.

In the embodiment of FIGS. 7 and 8, the connectors 10 are hollow pockets extending from the screen panel 4 in which the attachment members 6, preferably in the form of magnets, are placed. The connectors 10 can be permanently attached to the screen panel 4, such as by stitching, adhesives, sealing, or the like, or removably attached to the screen panel 4, such as by the use of snaps, clips, Velcro, catches, pins, hooks or the like. Also, the pockets that form the connectors 10 may be openable or sealed about the attachment member 6.

Since it is preferred that the attachment member 6 be releasable from the screen panel 4 for washing, etc., it is preferred that the connector 10 be removable from the screen panel 4 when the attachment member 6 is permanently enclosed in or affixed to the connector 10. For the same reason, it is preferred that the connector 10 have an openable pocket or other means for separating the attachment member 6 from the screen panel 4 when the connector 6 is permanently attached to the screen panel 4.

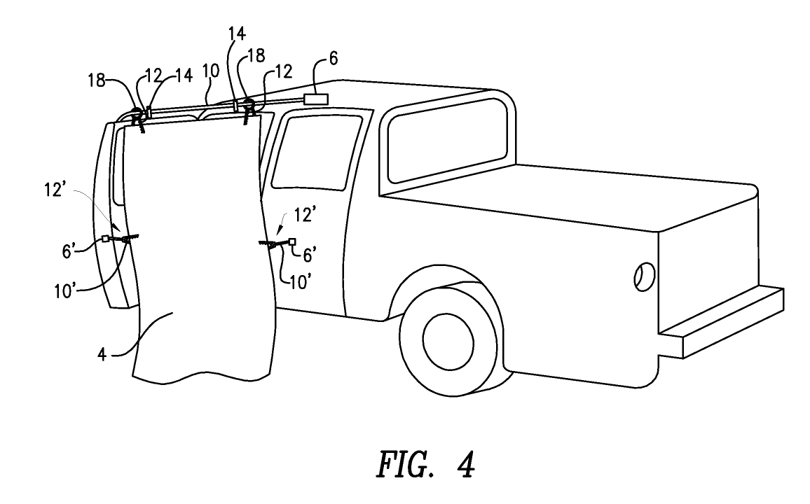

Of course, there may be more than one pair of attachment members 6 connected to the screen panel 4. Connectors 10 can connect attachment members 6 to different locations of the screen panel 4, including the bottom corners as shown in FIGS. 5, 6, 7 and 8 or middle portions as shown in FIG. 4. These can be used at opposing areas of the screen panel, or at single locations (not shown), as desired.

As discussed above, the removable attachment members 6 can be any device that is removably attachable to the vehicle and is capable of supporting the screen panel 4 in a screening position. In a preferred embodiment, the removable attachment member 6 can be one or more magnets, suction cups, static films, hooks, clips, straps or the like, or combinations thereof, with magnets being most preferred. In this regard, magnets can provide a strong attachment to the vehicle, while suction cups may be prone to the effects of a moist or dirty vehicle surface, accidental movement or unfastening because of human body movement or wind.

When magnets or other metallic attachment members 6 are used, it is preferred that they have a non-scratch covering, either a coating layer or a cover, so that they do not mark the finish of the vehicle. Rubber or latex coatings or covers, on at least the portion of the magnet that would be expected to come into contact with the vehicle surface, are most preferred, although fabric, plastic or other coverings could be used. Alternatively, the attachment members 6 can be placed in a closed or openable pocket that forms the connector 10, with the pocket preferably extending the length of the connector 10, or a strap, line, cord, string, rope or the like to connect the pocket of the connection member 8 to the screen panel 4.

As shown in FIG. 4, the connector 10 can be a strap, line, string, cord, and/or rope with removable attachment members 6 in the form of magnets affixed to both ends. The magnets are affixed to the ends of the connector 10 by adhesive or with use of magnets having apertures, feeding the line through the aperture and knotting it. One of the attachment members 6 is then preferably placed on the roof of the vehicle and another is placed on the door of the vehicle.

Of course, the attachment members 6 need not be the same about the screen panel 4. One of the attachment members 6 can be a magnet attached to the roof of the vehicle and the other may be a Velcro tab or clip that can be attached about the top of a frame of the window on the vehicle door (not shown).

FIG. 4 illustrates an alternative embodiment of the present invention with a minimum of two (2) retention members 12 in the form of clips that are attached to the connector 10, in the form of a strap, line, string, cord, and/or rope, by rings 18. The rings 18 allow the clips to move along the line for holding the opposed sides of the screen panel 4 at desired positions. The two clips can be fixed at desired positions through the use of adjustable sliders or movable stops 14. Two additional connectors 10′ in the form of short pieces of line, string, cord, and/or rope each have a smaller magnet as an attachment member 6′ to hold the sides of the screen panel 4 in place.

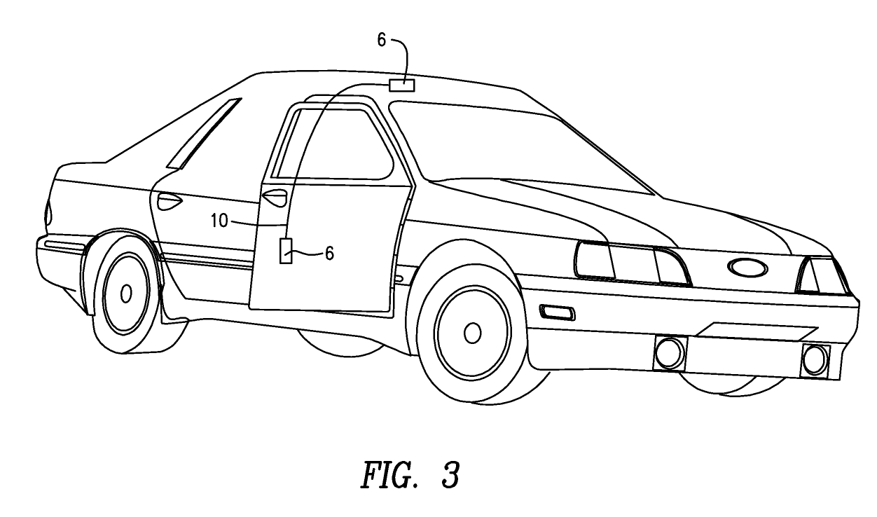

As shown in FIG. 4, the preferred embodiment of the present invention is for use on a vehicle with the door in the open position. The connectors 10, with attachment members 6 in the form of magnets at each end, are used to provide the screen panel 4 with horizontal support. One attachment member 6 of the horizontal support line is placed on the roof of the vehicle. In the embodiment of FIG. 4, the connector 10 is in the form of a line, string, cord, and/or rope is then laid over the top portion of the door frame or window of the open vehicle door. The other magnet of the horizontal support line is placed on a metal portion of the door, as illustrated in FIG. 3. Of course, if the connectors 10 are attached to each of the sides of the screen panel 4, they would attach to the vehicle in the same way, with the top of the screen panel 4 extending over the top of the door frame or window of the open vehicle door.

When the strap, line, string, cord, and/or rope is used across the entire top of the screen panel 4, the natural or synthetic fabric that makes up the screen panel may be clipped to the horizontally laid strap, line, string, cord, and/or rope, providing a screen and/or drape of the area between the open vehicle door and vehicle compartment. Secondary attachment members 6′ coupled to connection members 12′ formed with short connectors 10′ are clipped to each vertical side of the hanging screen panel 4, and the magnets are attached to the vehicle and vehicle door to provide lateral support. (See FIG. 4). All magnets can be moved, or can be adjustably coupled to the connectors, to adjust for fabric tautness and maximum privacy.

A preferred embodiment shown in FIGS. 7 and 8 contemplates the attachment members 6, such as magnets, on or within pockets formed as the connectors 10 that extend from the screen panel 4 to connect the attachment members 6 to the screen panel 4. Of course, the connector 10 can be a strap, line, string, cord, and/or rope between the screen panel 4 and the attachment member 6, rather than the pocket, with the attachment member 6 either permanently or removably attached to the connector 10. Preferably, the connectors 10 extend the attachment members 6 from about 4 to about 12 inches from the screen panel 4, and most preferably from about 6 to about 10 inches from the screen panel 4.

In the embodiment of FIGS. 7 and 8, the retention member 12 that holds the connectors 10 to the screen panel 4 can be permanent, such as stitching, adhesives, sealing, riveting, etc., or removable, such as snaps, Velcro, ties, clips, clamps, or the like, as long as the attachment member 6 can be coupled to the screen panel 4.

In the most preferred embodiment of the invention shown in FIGS. 7 and 8, the connectors 10 comprise pockets in which magnets are placed. The pockets of the connectors 10 can be openable for removal of the attachment member 6 during washing, etc., generally as shown in FIG. 7, or permanently closed, i.e., sewn shut for permanent containment of the attachment member 6, generally as shown in FIG. 8. In this regard, when openable, the preferred connection members 10 would have a releasable closure 32, such as cooperating Velcro strips, clips, overlapping pocket ends, snaps or the like to keep the attachment member 6 from accidently falling out.

Most preferably, the connectors 10 comprise pockets from the point of the retention member 12, which holds the connectors 10 to the screen panel 4, to the end of the terminal ends of the connectors 10 that extend beyond the screen panel 4. When so configured, the attachment member 6 can be moved along the length of the connector 10 for more precise placement of the attachment member 6 on the vehicle. Alternatively, the attachment member 6 could be fixed at the terminal end of the connector 10, or at a point in between.

Another preferred element of the invention, shown in FIGS. 7 and 8, is the use of indicators 30 to distinguish the top of the screen panel 4 from the bottom of the screen panel 4. Although any indicator 30 can be used, including a color strip along the top of the screen panel 4, a preferred indicator 30 is the use of contrasting color connectors 10 at the top of the screen panel 4. Thus, a user seeing the indicator 30 knows to place those toward the top of the vehicle.

In its most preferred form, the privacy screen 2 of the present invention includes a storage pocket 34 on the screen panel 4 for holding the privacy screen 2 when not in use. The storage pocket 34 can be attached to the screen panel 4 in any way or at any suitable location, but it is preferred that the storage pocket 34 is attached on the screen panel 4 about three sides, by stitching, gluing, sealing, or the like, rather than hanging off of an edge of the screen panel 4.

Additionally, it is preferred that the storage pocket 34 have a storage closure 36 for keeping the privacy screen 2 from accidently falling out of the storage pocket 34. Although any suitable storage closure can be used, including Velcro, clips, pins, snaps, clasps or the like, most preferred is a drawstring with a movable line clamp 38 to hold the drawstring closed.

Of course, combinations of the above described elements to create the desired privacy screen 2 are contemplated. Also, the attachment member 6 can be a combination of different types to ensure that they attach to the vehicle, i.e., magnets and clips, or clips with cooperating magnets that can be coupled to magnetic attachment members 6, for clipping one or more connectors 10 to a convertible roof.

Variations, modifications and alterations to the preferred embodiment of the present invention described above will make themselves apparent to those skilled in the art. All such changes are intended to fall within the spirit and scope of the present invention, limited solely by the appended claims.

We claim:

1. A vehicle mounted privacy screen comprising a screen panel having a top and a bottom, at least one removable attachment member associated with each of at least two opposed portions relative to the top of the screen panel, and a connection member extending from the screen panel that connects the screen panel to the at least one removable attachment member.

2. The vehicle mounted privacy screen of claim 1 wherein the screen panel comprises a sheet of lightweight material.

3. The vehicle mounted privacy screen of claim 1 wherein the screen panel is a rectangle.

4. The vehicle mounted privacy screen of claim 1 wherein the screen panel has a window extension section for covering an adjacent window of a vehicle on which the vehicle mounted privacy screen is mounted.

5. The vehicle mounted privacy screen of claim 1 wherein the removable attachment member is taken from the group consisting of a magnet, a suction cup, a static film, a clip, a hook and a strap.

6. The vehicle mounted privacy screen of claim 5 wherein the removable attachment member is a magnet.

7. The vehicle mounted privacy screen of claim 1 wherein the connection member comprises a connector and a retention member, where the connector is coupled to or contains the attachment member.

8. The vehicle mounted privacy screen of claim 7 wherein the connector is taken from the group consisting of a line, string, rope, wire, a pocket and a strap.

9. The vehicle mounted privacy screen of claim 7 wherein the retention member is taken from the group consisting of holes, rings, grommets, rivets, clips, catches, snaps, clamps, crimps, clasps, hook and loop fasteners, pins, tabs, stitching, adhesive, sealing and fasteners.

10. The vehicle mounted privacy screen of claim 7 wherein the connection member is formed of a pocket in which the attachment member is held.

11. The vehicle mounted privacy screen of claim 10 wherein the pocket taken from the group consisting of a permanently closed pocket and an openable pocket.

12. The vehicle mounted privacy screen of claim 9 wherein the retention member comprises a release element for releasing the connection member from the screen panel.

13. The vehicle mounted privacy screen of claim 1 further comprising a storage pocket on the screen panel for holding the privacy screen when not in use, said storage pocket including a closure for at least partially maintaining the privacy screen in the storage pocket.

14. The vehicle mounted privacy screen of claim 7 wherein the connector is permanently attached to the screen panel and comprises a coupling element for coupling to the attachment member.

15. The vehicle mounted privacy screen of claim 1 wherein the privacy screen further comprises at least one additional attachment member and connection member for securing an additional portion of the screen panel to a vehicle.

16. The vehicle mounted privacy screen of claim 1 further comprising one or more indicators for easy orientation of the privacy screen on the vehicle.

17. The vehicle mounted privacy screen of claim 7 wherein the connector is an openable pocket with a closure taken from one of hook and loop fasteners, clips, snaps, clasps and overlapping pocket ends.

18. The vehicle mounted privacy screen of claim 13 wherein the closure of the storage pocket comprises a drawstring with a movable stop.

19. A vehicle mounted privacy screen comprising a screen panel having a top and a bottom, at least one removable attachment member associated with each of at least two opposed portions of the screen panel and a connection member that connects the screen panel to the removable attachment member, said connection member comprising a connector that extends from the screen panel which is coupled to the attachment member and a retention member that is coupled to the screen panel, wherein the attachment member is a magnet and the connector comprises a pocket in which the magnet is disposed.
